(19) United States
(12) Patent Application Publication
(10) Pub. No.: US 2025/0105977 A1
(43) Pub. Date: Mar. 27, 2025

(54) SIMULTANEOUS UNIFIED TCI STATE UPDATE FOR A GROUP OF CELLS

(71) Applicant: LENOVO (BEIJING) LIMITED, Beijing (CN)

(72) Inventors: Bingchao LIU, Beijing (CN); Chenxi ZHU, Fairfax, VA (US); Wei LING, Beijing (CN); Yi ZHANG, Beijing (CN); Lingling XIAO, Beijing (CN)

(21) Appl. No.: 18/290,983

(22) PCT Filed: Jul. 23, 2021
(86) PCT No.: PCT/CN2021/108127

§ 371 Date: Jan. 22, 2024

(51) Int. Cl. H04L 5/00; H04W 72/1263

(52) U.S. Cl. CPC H04L 5/0053; H04L 5/001; H04L 5/0048; H04W 72/1263

(57) ABSTRACT

Methods and apparatuses for simultaneous unified TCI state update for a group of cells are disclosed. A method comprises receiving a configuration of one or more CC lists, simultaneous TCI state update is supported for all CCs in each CC list; receiving, for a CC list, an indication of common TCI state in one CC in the CC list to update TCI states of all CCs in the CC list, wherein, TCI state ID(s) are included in the indication of common TCI state; determining, for the CC list, application time of the common TCI state, the application time is based on a reference SCS; and applying the TCI state ID(s) included in the indication of common TCI state to all of CCs in the CC list after the determined application time.

### FIELD

The subject matter disclosed herein generally relates to wireless communications, and more particularly relates to methods and apparatuses for simultaneous unified TCI state update for a group of cells.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Downlink control information (DCI), Transmission Reference Point (TRP), Physical Downlink Control Channel (PDCCH), Physical Downlink Shared Channel (PDSCH), Information Element (IE), component carrier (CC), Media Access Control (MAC), control element (CE), band width part (BWP), control resource set (CORESET), Sounding Reference Signal (SRS), transmission configuration indication or transmission configuration indicator (TCI), Physical Uplink Control Channel (PUCCH), Physical Uplink Shared Channel (PUSCH), primary cell (PCell), secondary cell (SCell), master cell group (MCG), secondary cell group (SCG), primary secondary cell (PSCell), Carrier Aggregation (CA), subcarrier spacing (SCS), pathloss reference signal (PL-RS), Frequency range 2 (FR2): corresponding to 24.25 GHz˜52.6 GHz.

To support higher efficient operation in FR2, transmission configuration indication (TCI) framework was introduced in NR Release 15. For DL transmission including PDCCH and PDSCH transmissions, the gNB indicates a TCI state for each PDCCH and PDSCH transmission. The UE shall determine the DL RX spatial filter according to a source DL RS with QCL-TypeD contained in the indicated TCI state. For UL transmission, the UL TX spatial filter for each PUCCH resource and each SRS resource is determined by a RS configured as the spatialRelationInfo for each PUCCH resource or SRS resource. Based on NR Release 15 and Release 16 TCI framework, simultaneous TCI state update for a group of CCs in a configured CC list is specified. For example, a UE can be configured with two CC lists, where the TCI state ID(s) of the TCI state for PDCCH or PDSCH transmissions for all CCs in a same CC list can be simultaneously updated by a MAC CE applying to any one BWP of any one CC in the CC list. When the UE receives the MAC CE to activate one TCI state for a CORESET in a cell and if the CC corresponding to the cell belongs to a configured CC list, the UE shall applies the TCI state with the same TCI State ID to all the CORESETs with the same CORESET ID in all the CCs in the configured CC list. The same mechanism is introduced for the spatial relation update for SRS resource as well as the TCI state update for PDSCH for a set of CCs by MAC CE.

Unified TCI framework for both DL and UL is introduced in NR Release 17, where all PDCCH and PDSCH transmissions in a cell may share a same indicated TCI state and all PUCCH and PUSCH transmissions in a cell may share a same indicated UL TCI state. DCI based TCI state update for all PDCCH and PDSCH transmissions of a cell and DCI based UL TCI state update for all PUCCH and PUSCH transmissions of a cell are also agreed to be supported for unified TCI framework.

The following issues are needed to be addressed: how to configure or determine cell lists (or CC list); how to determine the TCI state for the a cell without configured TCI state pool; how to define the UE behavior for the case that different cells corresponding to CCs in a CC list have different numerologies (e.g. SCSs); and how the UE determines the power control related parameters along with the joint DL/UL TCI state (which means joint DL and UL state) update or UL TCI state update. For joint DL/UL TCI state, one common TCI state is indicated to the UE to determine both DL RX spatial filter for PDCCH and PDSCH reception and UL TX spatial filter for PUSCH and PUCCH transmission in a carrier. For separate DL/UL TCI state, one DL TCI state is indicated as the common DL TCI state to determine the DL RX spatial filter for PDCCH and PDSCH reception and one UL TCI state is indicated as the common UL TCI state to determine the UL TX spatial filter for PUSCH and PUCCH transmission in a carrier.

This invention targets the above issues.

### BRIEF SUMMARY

Methods and apparatuses for simultaneous TCI state update for a group of cells are disclosed.

In one embodiment, a method comprises receiving a configuration of one or more CC lists, simultaneous TCI state update is supported for all CCs in each CC list; receiving, for a CC list, an indication of common TCI state in one CC in the CC list to update TCI states of all CCs in the CC list, wherein, TCI state ID(s) are included in the indication of common TCI state; determining, for the CC list, application time of the common TCI state, the application time is based on a reference SCS; and applying the TCI state ID(s) included in the indication of common TCI state to all of CCs in the CC list after the determined application time.

In one embodiment, for a UE configured with joint DL/UL TCI, each CC list is one of simultaneousTCI-UpdateList1-r16 and simultaneousTCI-UpdateList2-r16 supported in NR Release 16, and for a UE configured with separate DL/UL TCI, each CC list for simultaneous DL TCI state update is one of simultaneousTCI-UpdateList1-r16 and simultaneousTCI-UpdateList2-r16 supported in NR Release 16, and each CC list for simultaneous UL TCI state update is one of simultaneousSpatial-UpdatedList1-r16 and simultaneousSpatial-UpdatedList2-r16 supported in NR Release 16. In some embodiment, for a UE configured with inter-band CA, all CCs within a same CC list are configured with either joint DL/UL TCI or separate DL/UL TCI, and for a UE configured with intra-band CA, all the configured CCs belong to a same CC list, and a higher layer parameter is configured to enable simultaneous TCI state update for all the configured CCs of the same CC list.

In another embodiment, the method may further comprise determining a reference CC of each CC list if at least one CC in the CC list is not configured with a TCI state pool, where each TCI state pool consists of multiple TCI states configured by RRC signaling and the indicated or the activated TCI state is selected from a TCI state pool, where indicated TCI state refers to a TCI state indicated by DCI while activated TCI state refers to a TCI state activated by a MAC CE). One reference CC may be explicitly configured for each CC list. For a CC without configured TCI state pool, a reference CC may be contained in the PDSCH configuration for the cell corresponding to the CC. The reference CC of each CC list may be determined by the follow steps: if the CC corresponding to a PCell is contained in the CC list, the CC corresponding to the PCell is determined as the reference CC; else if the CC corresponding to a PSCell is contained in the CC list, the CC corresponding to the PSCell is determined as the reference CC; otherwise, the CC corresponding to the cell with the lowest serving cell ID among all the cells, the corresponding CCs of which belong to the CC list, is determined as the reference CC. Alternatively, the CC corresponding to the cell with the lowest serving cell ID among all the cells, the corresponding CCs of which belong to the CC list, may be directly determined as the reference CC.

In still another embodiment, the reference SCS of each CC list is determined by one of: the smallest SCS among SCSs of all the CCs in the CC list; the largest SCS among SCSs of all the CCs in the CC list; the SCS configured for the reference CC of the CC list; and the SCS configured for the CC in which the PUCCH carrying the acknowledgment for the DCI indication of common TCI state is transmitted.

In some embodiment, the method may further comprise updating a PL-RS for PUSCH or PUCCH transmission when receiving the indication of common TCI state; and updating the setting of (P0, alpha, closed loop index) for PUSCH and PUCCH transmissions when receiving the indication of common TCI state. If the cell corresponding to a CC is configured with TCI state pool(s) and each activated joint DL/UL TCI state or UL TCI state is associated with a PL-RS, the PL-RS is updated with the PL-RS associated with the joint DL/UL TCI state or UL TCI state configured in the CC having the same TCI state ID that is indicated or activated as the new TCI state; and if the cell corresponding to a CC is not configured with TCI state pool, the PL-RS is updated with the PL-RS associated with indicated or activated joint DL/UL TCI state or UL TCI state. If the cell corresponding to a CC is configured with TCI state pool(s) and a setting of (P0, alpha, closed loop index) for PUSCH transmission and a setting of (P0, closed loop index) for PUCCH transmission are associated with each joint DL/UL TCI state or UL TCI state, the (P0, alpha, closed loop index) is updated for PUSCH transmission with that associated with the joint DL/UL TCI state or UL TCI state configured in the CC having the same TCI state ID that is indicated or activated as the new TCI state, and the (P0, closed loop index) for PUCCH transmission is updated with that associated with that associated with the joint DL/UL TCI state or UL TCI state configured in the CC having the same TCI state ID that is indicated or activated as the new TCI state.

In one embodiment, a method comprises transmitting a configuration of one or more CC lists, simultaneous TCI state update is supported for all CCs in each CC list; transmitting, for a CC list, an indication of common TCI state in one CC in the CC list to update TCI states of all CCs in the CC list, wherein, TCI state ID(s) are included in the indication of common TCI state; and determining, for the CC list, application time of the common TCI state, the application time is based on a reference SCS.

In another embodiment, a remote unit (UE) comprises a receiver that receives a configuration of one or more CC lists, simultaneous TCI state update is supported for all CCs in each CC list, and receives, for a CC list, an indication of common TCI state in one CC in the CC list to update TCI states of all CCs in the CC list, wherein, TCI state ID(s) are included in the indication of common TCI state; and a processor that determines, for the CC list, application time of the common TCI state, the application time is based on a reference SCS, and applies the TCI state ID(s) included in the indication of common TCI state to all of CCs in the CC list after the determined application time.

In yet another embodiment, a base unit comprises a transmitter that transmits a configuration of one or more CC lists, simultaneous TCI state update is supported for all CCs in each CC list, and transmits, for a CC list, an indication of common TCI state in one CC in the CC list to update TCI states of all CCs in the CC list, wherein, TCI state ID(s) are included in the indication of common TCI state; and a processor that determines, for the CC list, application time of the common TCI state, the application time is based on a reference SCS.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of a third embodiment;

FIG. 2 is a schematic flow chart diagram illustrating an embodiment of a method;

FIG. 3 is a schematic flow chart diagram illustrating a further embodiment of a method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

First, several concepts used in the present disclosure are clarified as follows.

A band refers to a frequency range that for example can be allocated to an operator. A band includes several carriers, each of which occupies a different frequency range. One or more carriers can be configured for a UE as different serving cells. Each serving cell corresponds to a carrier. If a UE is configured with carrier aggregation operation, multiple carriers may be configured for a UE where one carrier is configured as primary cell (PCell), and the other carriers are configured as secondary cells (SCell). If a UE is configured with dual connectivity operation, two cell groups are configured, where each cell group is consisted of multiple carriers. One cell group is configured as master cell group (MCG) and the other cell group is configured as secondary cell group (SCG). The primary cell of MCG is called PCell and the primary cell of SCG called PSCell. Each of the secondary cells in MCG and in SCG is called SCell. A serving cell refers to a PCell or a PSCell or a SCell.

CC is an abbreviation of component carrier. In the present disclosure, CC is used as an abbreviation of carrier for a UE. In other words, a CC is a carrier configured for a UE. In the following description, component carrier, carrier and CC have the same meaning.

A CC list is composed of a group of CCs. A cell list is composed of a group of cells. In the following description, one cell corresponds to one CC. So, a cell list (composed of a group of cells) is substantially equivalent to a CC list (composed of a group of CCs, each of which corresponds to one cell of the group of cells. In the following description, CC list is used.

A cell in a CC list can be understood as the CC corresponding to the cell in the CC list.

Carrier Aggregation (CA) means that two or more component carriers (CCs) are aggregated together to support larger bandwidth transmission for a UE. Intra-band CA means that two or more component carriers (CCs) in one band are aggregated together for a UE. Inter-band CA means that two or more component carriers (CCs) in multiple bands (e.g. 2 bands) are aggregated together for a UE.

Usually, all carriers (CCs) in one band belong to one CC list. From another point of view, a CC list is composed of all CCs in a same band. Accordingly, in intra-band CA, there is usually only one CC list, while in inter-band CA, there are usually multiple CC lists, each of which is composed of all CCs in one band.

Each carrier (CC) has different BWPs. Each BWP corresponds to a part of a bandwidth of the carrier. The indicated TCI state to a carrier shall apply to all the BWPs in the carrier. If TCI state of a carrier (CC) is activated or updated to a new TCI state with a new ID, the indicated new TCI state shall also apply to all BWPs of the carrier.

A first embodiment relates to the configuration or determination of CC list.

According to a first sub-embodiment of the first embodiment, the CC lists supported in NR Release 16 are reused.

In NR Release 16, separate CC lists are supported for simultaneous TCI state update for DL channel as well as simultaneous spatial relation update for SRS for a group of cells (i.e. for a group of CCs each of which corresponds to one cell of the group of cells). In particular, simultaneousTCI-UpdateList1-r16 and simultaneousTCI-UpdateList2-r16 are configured by RRC signaling for simultaneous TCI state update for PDCCH and PDSCH. In addition, simultaneousSpatial-UpdatedList1-r16 and simultaneousSpatial-UpdatedList2-r16 are configured by RRC signaling for simultaneous spatial relation update for SRS.

According to the first sub-embodiment of the first embodiment, the CC lists supported in NR Release 16 (i.e. the above-mentioned simultaneousTCI-UpdateList1-r16, simultaneousTCI-UpdateList2-r16, simultaneousSpatial-UpdatedList1-r16 and simultaneousSpatial-UpdatedList2-r16) are reused.

When joint DL/UL TCI (which means DL RX spatial filter and UL TX spatial filter are determined by a same indicated TCI state) is configured, source RS for both DL RX spatial filter determination and UL TX spatial filter determination are indicated by a joint DL/UL TCI state indicated by joint TCI state ID. Therefore, simultaneousTCI-UpdateList1-r16 and simultaneousTCI-UpdateList2-r16 can be reused for simultaneous joint DL/UL TCI state update or activation for PDCCH, PDSCH, PUCCH, and PUSCH.

When separate DL/UL TCI (which means DL TCI state and UL TCI state are updated or activated separately) is configured, source RS for DL RX spatial filter determination is indicated by a DL TCI state indicated by a DL TCI state ID, while source RS for UL spatial filter determination is indicated by an UL TCI state indicated by an UL TCI state ID. Accordingly, simultaneousTCI-UpdateList1-r16 and simultaneousTCI-UpdateList2-r16 are used for simultaneous DL TCI state update or activation for PDCCH and PDSCH, and simultaneousSpatial-UpdatedList1-r16 and simultaneousSpatial-UpdatedList2-r16 are used for simultaneous UL TCI state update or activation for UE-dedicated PUCCH and PUSCH. UE-dedicated PUCCH refers to the PUCCH resources in RRC connection mode.

According to a second sub-embodiment of the first embodiment, additional dedicated CC lists are configured.

For inter-band CA, multiple dedicated CC lists can be configured for unified TCI framework. Each CC list can be composed of all CCs in a same band.

For joint DL/UL TCI, each CC list applies to joint DL/UL TCI state update. For example, simultaneousJointTCI-UpdateList1-r17, simultaneousJointTCI-UpdateList2-r17, simultaneousJointTCI-UpdateList3-r17, simultaneousJointTCI-UpdateList4-r17 can be configured for simultaneous joint DL/UL TCI state update.

For separate DL/UL TCI, separate CC lists are configured for UL TCI state update and DL TCI state update, separately. For example, simultaneousULTCI-UpdateList1-r17, simultaneousULTCI-UpdateList2-r17 are configured for simultaneous UL TCI state update; and simultaneousDLTCI-UpdateList1-r17, simultaneousDLTCI-UpdateList2-r17 are configured for simultaneous DL TCI state update.

For intra-band CA, all configured CCs belong to a same CC list by default. Moreover, one additional RRC parameter can be configured to enable simultaneous TCI state update for all CCs (e.g. for all BWPs of all CCs) of the CC list.

For example, a higher layer parameter enableSimultaneousJointTCI-Update can be configured to enable simultaneous joint DL/UL TCI state update for all CCs (e.g. for all configured BWPs in all CCs) for a UE configured with joint DL/UL TCI.

For another example, a higher layer parameter enableSimultaneousTCI-Update can be configured to enable simultaneous DL TCI state update as well as UL TCI state update for all CCs (e.g. for all configured BWPs in all CCs) for a UE configured with separate DL/UL TCI. Alternatively, simultaneous DL TCI state update for DL and simultaneous UL TCI state update for UL can be enabled separately. For example, for all CCs (e.g. for all configured BWPs in all CCs) for a UE configured with separate DL/UL TCI, a higher layer parameter enableSimultaneousDL-TCI-Update can be configured to enable simultaneous DL TCI state update, while another higher layer parameter enableSimultaneousUL-TCI-Update can be configured to enable simultaneous UL TCI state update.

In addition, the UE expects that all the CCs that belong to a same CC list are configured with a same unified TCI framework. It means that all the CCs that belong to a same CC list are configured with joint DL/UL TCI, or all the CCs that belong to a same CC list are configured with separate DL/UL TCI.

An example of the second sub-embodiment of the first embodiment is as follows:

A UE is configured with inter-band CA and joint DL/UL TCI, and 2 CC lists are configured: simultaneousJointTCI-UpdateList1-r17 (i.e. CC list #1)={CC #0, CC #1, CC #2, CC #3}; and simultaneousJointTCI-UpdateList2-r17 (i.e. CC list #2)={CC #4, CC #5, CC #6, CC #7}.

A second embodiment relates to a reference CC for a CC list.

When a UE receives a DCI or MAC CE to update or activate TCI state ID for a CC, it is necessary that the CC has been configured with a TCI state pool including a plurality of candidate TCI states each of which is associated with a TCI state ID. It means that the UE updates the TCI state to a TCI state contained in the configured TCI state pool that is associated with a TCI state ID that is the same as the indicated or activated TCI state ID. In the scenario of simultaneous TCI state update and activation for a CC list composed of a group of CCs, common TCI state ID(s) are included in the DCI or MAC CE for simultaneous TCI state update or activation to update or activate the TCI state ID(s) of all CCs in the CC list, and in particular, to update or activate the TCI state ID(s) of all BWPs in all the CCs in the CC list. However, some CC(s) may not have been configured with a TCI state pool.

To support simultaneous TCI state update or activation for a CC without configured TCI state pool, a concept of “reference CC” is introduced. The PDSCH configuration of the reference CC is configured with TCI state pool(s) by RRC signaling. For a CC without configured TCI state pool(s) but configured with a reference CC, the UE applies the configured TCI state pool(s) in the reference CC to the CC without configured TCI state pool(s).

According to a first sub-embodiment of the second embodiment, one reference CC is explicitly configured per CC list by RRC signaling.

For example, when CC lists supported in NR Release 16 (i.e. simultaneousTCI-UpdateList1-r16, simultaneousTCI-UpdateList2-r16, simultaneousSpatial-UpdatedList1-r16 and simultaneousSpatial-UpdatedList2-r16) are reused for a UE configured with separate DL/UL TCI, the gNB can configure one reference CC for each CC list by using the following signaling configured in CellGroupConfig IE which configures the cell information for multiple carrier operation.

CellGroupConfig ::= SEQUENCE {
...

| | |
|---|---|
| simultaneousTCI-UpdateList1-r16 | SEQUENCE (SIZE (1..maxNrofServingCellsTCI-r16)) OF ServCellIndex |
| simultaneousTCI-UpdateList2-r16 | SEQUENCE (SIZE (1..maxNrofServingCellsTCI-r16)) OF ServCellIndex |
| simultaneousSpatial-UpdatedList1-r16 | SEQUENCE (SIZE (1..maxNrofServingCellsTCI-r16)) OF ServCellIndex |
| simultaneousSpatial-UpdatedList2-r16 | SEQUENCE (SIZE (1..maxNrofServingCellsTCI-r16)) OF ServCellIndex |
| referenceCellForsimultaneousTCI-UpdateList1-r16 | ServCellIndex |
| referenceCellForsimultaneousTCI-UpdateList2-r16 | ServCellIndex |
| referenceCellsimultaneousSpatial-UpdatedList1-r16 | ServCellIndex |
| referenceCellsimultaneousSpatial-UpdatedList1-r16 | ServCellIndex |

...
}

In the above CellGroupConfig IE, a higher layer parameter referenceCellForsimultaneousTCI-UpdateList1-r16 indicates the reference CC for simultaneousTCI-UpdateList1-r16, a higher layer parameter referenceCellForsimultaneousTCI-UpdateList2-r16 indicates the reference CC for simultaneousTCI-UpdateList2-r16, a higher layer parameter referenceCellForsimultaneousSpatial-UpdateList1-r16 indicates the reference CC for simultaneousSpatial-UpdateList1-r16, and a higher layer parameter referenceCellForsimultaneousSpatial-UpdateList2-r16 indicates the reference CC for simultaneousSpatial-UpdateList2-r16. A higher layer parameter maxNrofServingCellsTCI-r16 indicates the maximum number of serving cells in each of simultaneousTCI-UpdateList1-r16, simultaneousTCI-UpdateList2-r16, simultaneousSpatial-UpdateList1-r16, and simultaneousSpatial-UpdateList2-r16.

The configured reference CC, whose serving cell ID is identified by ServCellIndex, for each CC list belong to the CC list including the reference CC. For example, ServCellIndex configured as referenceCellForsimultaneousTCI-UpdateList1-r16 (which is for CC list simultaneousTCI-UpdateList1-r16) belongs to simultaneousTCI-UpdateList1-r16.

According to a second sub-embodiment of the second embodiment, one reference CC is contained (i.e. explicitly configured) in PDSCH configuration.

If the PDSCH configuration of a serving cell does not include configured TCI state pool(s), a reference CC can be contained in the PDSCH configuration (e.g. PDSCH-Config IE as follows).

| PDSCH-Config ::= | SEQUENCE { |
|---|---|
| ... | |
| referenceCell | ServCellIndex |

...
}

If one or more CC lists are configured for the UE, the indicated reference CC belongs to the CC list containing the CC (containing the CC corresponding to the cell). Obviously, the reference CC and TCI state pool(s) are not expected to be simultaneously configured for a cell (for the CC corresponding to the cell).

According to a third sub-embodiment of the second embodiment, one reference CC is implicitly determined according to the following procedure: For a CC list, if the CC corresponding to a PCell is contained in the CC list, the CC corresponding to the PCell is determined as the reference CC; else if the CC corresponding to a PSCell is contained in the CC list, the CC corresponding to the PSCell is determined as the reference CC; otherwise, the CC corresponding to the cell with the lowest serving cell ID among all the cells, the corresponding CCs of which belong to the CC list, is determined as the reference CC.

According to a fourth sub-embodiment of the second embodiment, one reference CC is implicitly determined. In particular, for a CC list, the CC corresponding to the cell with the lowest serving cell ID among all the cells, the corresponding CCs of which belong to the CC list, is determined as the reference CC.

An example of the second embodiment is as follows. Suppose that 2 CC lists (CC list #1 and CC list #2) in the example of the first embodiment are configured. In addition, the UE is configured with joint DL/UL TCI. According to any of the first sub-embodiment, second sub-embodiment and third sub-embodiment of the second embodiment, CC #0 is configured as the reference CC of CC list #1. Suppose that TCI state pool is only configured for CC #0 and CC #2. If the UE receives a DCI (or MAC CE) indicating a joint DL/UL TCI state update (i.e. including an indicated new TCI state ID) in CC #2, the UE updates the joint DL/UL TCI state for CC #0 with the TCI state in the TCI state pool configured for CC #0 having the same TCI State ID as the indicated TCI state ID in CC #2; updates the joint DL/UL TCI state for CC #2 with the TCI state in the TCI state pool configured for CC #2 having the same TCI State ID as the indicated TCI state ID in CC #2; updates the joint DL/UL TCI states for CC #1 and CC #3 with the TCI state in the TCI state pool configured for the reference CC (i.e., CC #0) having the same TCI state ID as the indicated TCI state ID in CC #2.

A third embodiment relates to determining the application time of the common TCI state indication for a CC list.

The application time of the common TCI state indication for a CC list means a time (e.g. a symbol) from which the indicate TCI state shall begin to apply for all CCs in the CC list (i.e. for all BWPs in all the CCs in the CC list).

The application time of the common TCI state indication begins from the first slot that is at least X ms or Y symbols after the last symbol of the PUCCH transmission carrying the acknowledgment (ACK) of the common TCI state indication (e.g. the joint or separate DL/UL TCI state indication). If the application time is configured as number of symbols and if different numerologies are configured for different CCs in a CC list (where each numerology corresponds a SCS and a CP configuration for a carrier, and different numerologies may have different SCSs), it is necessary to determine the application time based on a reference SCS since different SCSs correspond to different symbol durations if the application time is configured in terms of Y symbols.

According to a first sub-embodiment of the third embodiment, the application time is determined by the reference SCS that is the smallest SCS among SCSs of all the CCs in the CC list.

According to a second sub-embodiment of the third embodiment, the application time is determined by the reference SCS that is the largest SCS among SCSs of all the CCs in the CC list.

According to a third sub-embodiment of the third embodiment, the application time is determined by the reference SCS that is the SCS configured for the reference CC (e.g. the SCS of the active BWP of the reference CC).

According to a fourth sub-embodiment of the third embodiment, the application time is determined by the reference SCS that is the SCS configured for the BWP of the CC in which the PUCCH carrying the acknowledgment for the joint or separate DL/UL TCI state indication is transmitted.

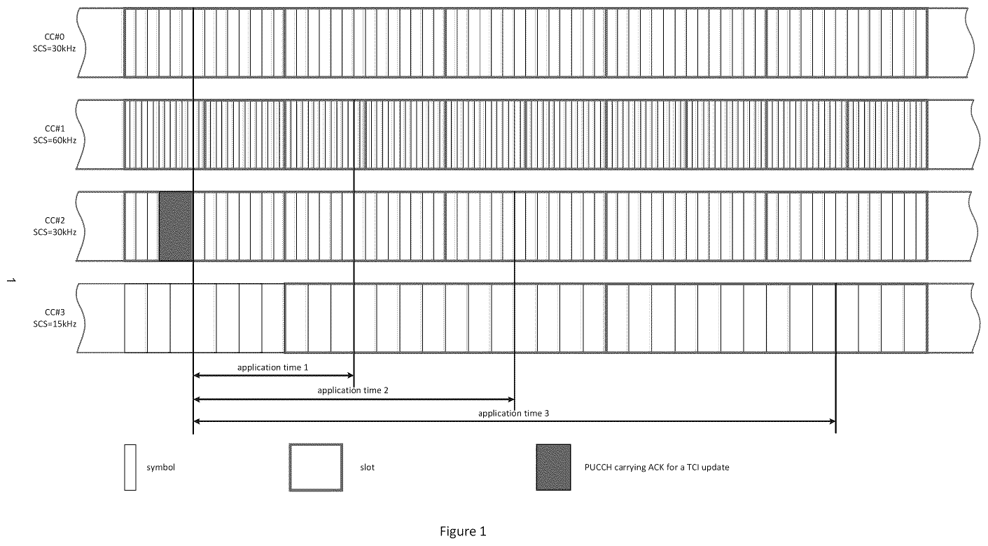

FIG. 1 illustrates an example of the third embodiment. Suppose that 2 CC lists (CC list #1 and CC list #2) in the example of the first embodiment are configured, and CC #0 is configured as the reference CC of CC list #1 (the same as the example of the second embodiment). The common TCI state indication is transmitted in CC #2 (e.g. a DCI indicating the common TCI state indication is received by the UE). The application time of the common TCI state indication is configured to begin from the first symbol that is Y symbols, e.g., 28 symbols, after the reception of the PUCCH transmission carrying an ACK to the common TCI state indication. Suppose CC #0 has a SCS of 30 kHz; CC #1 has a SCS of 60 kHz; CC #2 has a SCS of 30 kHz; and CC #3 has a SCS of 15 kHz.

Application time 1 is determined by the second sub-embodiment of the third embodiment, i.e. the largest SCS among all the CCs in CC list #1 (i.e., CC #1). Application time 2 is determined by the third sub-embodiment of the third embodiment, i.e. the SCS of the reference CC (i.e., CC #0). Application time 3 is determined by the first sub-embodiment of the third embodiment, i.e. the smallest SCS among all the CCs in CC list #1 (i.e., CC #3). Incidentally, although not illustrated in FIG. 1, if application time 4 is determined by the fourth sub-embodiment of the third embodiment, i.e. the SCS configured for the BWP of the CC in which the PUCCH carrying the acknowledgment for the common TCI state indication is transmitted (i.e. CC #2), application time 4 is the same as application time 2 (since CC #2 and CC #0 have the same SCS.

Suppose that the common TCI state indication is joint DL/UL TCI state indication, the UE updates the joint DL/UL TCI state for each of CC #0, CC #1, CC #2 and CC #3 after the determined application time (i.e. one of Application time 1, Application time 2, Application time 3 and Application time 4). The TCI state to be updated in each of CC #0, CC #1, CC #2 and CC #3 has been discussed in the example of the third embodiment.

A fourth embodiment relates to the update of power control related parameters.

A PL-RS which is used for the DL channel pathloss estimation to determine the transmit power for PUSCH or PUCCH transmission is associated with a joint DL/UL TCI state or a UL TCI state. The setting of other power control parameters including P0 (which configures the target receive power at gNB), alpha (which configures a factor for partial pathloss compensation), closed loop index (which indicates a closed loop index for closed loop power control) for PUSCH or PUCCH transmissions can be associated with a UL TCI state or joint DL/UL TCI state. If simultaneous TCI state update for a CC list (composed of a group of CCs) is configured, the associated power control parameters for the group of CCs can also be updated at the same time.

When a UE receives a simultaneous TCI state update or activation for a cell corresponding to a CC that belongs to a CC list, for each CC on which TCI state pool(s) are configured in the CC list, the UE shall update the PL-RS for PUSCH or PUCCH transmissions with the PL-RS associated with the joint DL/UL TCI state or UL TCI state having the same TCI state ID as that indicated or activated as the new TCI state ID. If a setting of (P0, alpha, closed loop index) for PUSCH transmission is associated with each joint DL/UL TCI state or UL TCI state, the UE shall update the (P0, alpha, closed loop index) for PUSCH transmission with that associated with the same TCI state ID as that indicated or activated as the new TCI state ID. If a setting of (P0, closed loop index) for PUCCH transmission is associated with each joint DL/UL TCI state or UL TCI state, the UE shall update the (P0, closed loop index) for PUCCH transmission with that associated with the same TCI state ID as that indicated or activated as the new TCI state ID.

When a UE receives a simultaneous TCI state update or activation for a cell corresponding to a CC that belongs to a CC list, for each CC on which TCI state pool is not configured in the CC list, the UE shall update the PL-RS for PUSCH or PUCCH transmission with the PL-RS associated with the joint DL/UL TCI state or UL TCI state having the same TCI state ID as that indicated or activated as the new TCI state ID. The setting of (P0, alpha, closed loop index) for PUSCH transmission or the setting of (P0, closed loop index) for PUCCH transmission are not updated.

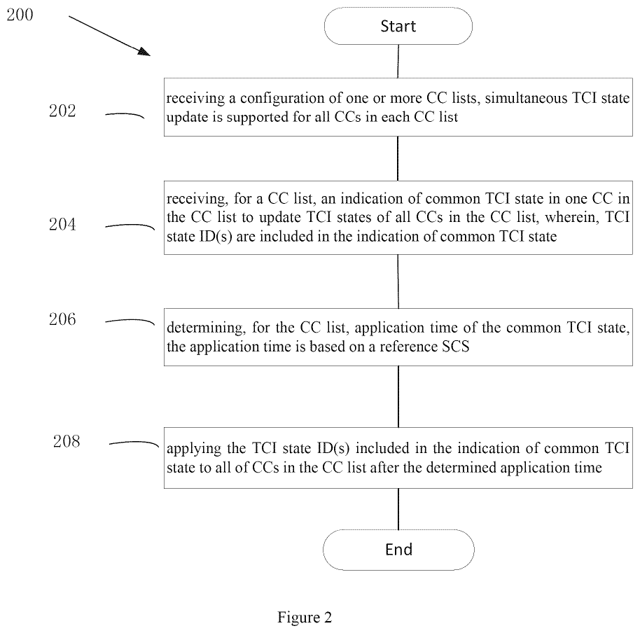

FIG. 2 is a schematic flow chart diagram illustrating an embodiment of a method 200 according to the present application. In some embodiments, the method 200 is performed by an apparatus, such as a remote unit (UE). In certain embodiments, the method 200 may be performed by a processor executing program code, for example, a microcontroller, a microprocessor, a CPU, a GPU, an auxiliary processing unit, a FPGA, or the like.

The method 200 may comprise 202 receiving a configuration of one or more CC lists, simultaneous TCI state update is supported for all CCs in each CC list; 204 receiving, for a CC list, an indication of common TCI state in one CC in the CC list to update TCI states of all CCs in the CC list, wherein, TCI state ID(s) are included in the indication of common TCI state; 206 determining, for the CC list, application time of the common TCI state, the application time is based on a reference SCS; and 208 applying the TCI state ID(s) included in the indication of common TCI state to all of CCs in the CC list after the determined application time.

In one embodiment, for a UE configured with joint DL/UL TCI, each CC list is one of simultaneousTCI-UpdateList1-r16 and simultaneousTCI-UpdateList2-r16 supported in NR Release 16, and for a UE configured with separate DL/UL TCI, each CC list for simultaneous DL TCI state update is one of simultaneousTCI-UpdateList1-r16 and simultaneousTCI-UpdateList2-r16 supported in NR Release 16, and each CC list for simultaneous UL TCI state update is one of simultaneousSpatial-UpdatedList1-r16 and simultaneousSpatial-UpdatedList2-r16 supported in NR Release 16. In some embodiment, for a UE configured with inter-band CA, all CCs within a same CC list are configured with either joint DL/UL TCI or separate DL/UL TCI, and for a UE configured with intra-band CA, all the configured CCs belong to a same CC list, and a higher layer parameter is configured to enable simultaneous TCI state update for all the configured CCs of the same CC list.

In another embodiment, the method may further comprise determining a reference CC of each CC list if at least one CC in the CC list is not configured with a TCI state pool. One reference CC may be explicitly configured for each CC list. For a CC without configured TCI state pool, a reference CC may be contained in the PDSCH configuration for the cell corresponding to the CC. The reference CC of each CC list may be determined by the follow steps: if the CC corresponding to a PCell is contained in the CC list, the CC corresponding to the PCell is determined as the reference CC; else if the CC corresponding to a PSCell is contained in the CC list, the CC corresponding to the PSCell is determined as the reference CC; otherwise, the CC corresponding to the cell with the lowest serving cell ID among all the cells, the corresponding CCs of which belong to the CC list, is determined as the reference CC. Alternatively, the CC corresponding to the cell with the lowest serving cell ID among all the cells, the corresponding CCs of which belong to the CC list, may be directly determined as the reference CC.

In some embodiment, the reference SCS of each CC list is determined by one of: the smallest SCS among SCSs of all the CCs in the CC list; the largest SCS among SCSs of all the CCs in the CC list; the SCS configured for the reference CC of the CC list; and the SCS configured for the CC in which the PUCCH carrying the acknowledgment for the indication of common TCI state is transmitted.

In some embodiment, the method may further comprise updating a PL-RS for PUSCH or PUCCH transmission when receiving the indication of common TCI state; and updating the setting of (P0, alpha, closed loop index) for PUSCH and PUCCH transmissions when receiving the indication of common TCI state. If the cell corresponding to a CC is configured with TCI state pool(s) and each joint DL/UL TCI state or UL TCI state is associated with a PL-RS, the PL-RS is updated with the PL-RS associated with the joint DL/UL TCI state or UL TCI state configured in the CC having the same TCI state ID that is indicated or activated as the new TCI state; and if the cell corresponding to a CC is not configured with TCI state pool, the PL-RS is updated with the PL-RS associated with indicated or activated joint DL/UL TCI state or UL TCI state. If the cell corresponding to a CC is configured with TCI state pool(s) and a setting of (P0, alpha, closed loop index) for PUSCH transmission and a setting of (P0, closed loop index) for PUCCH transmission are associated with each joint DL/UL TCI state or UL TCI state, the (P0, alpha, closed loop index) is updated for PUSCH transmission with that associated with the joint DL/UL TCI state or UL TCI state configured in the CC having the same TCI state ID that is indicated or activated as the new TCI state, and the (P0, closed loop index) for PUCCH transmission is updated with that associated with that associated with the joint DL/UL TCI state or UL TCI state configured in the CC having the same TCI state ID that is indicated or activated as the new TCI state.

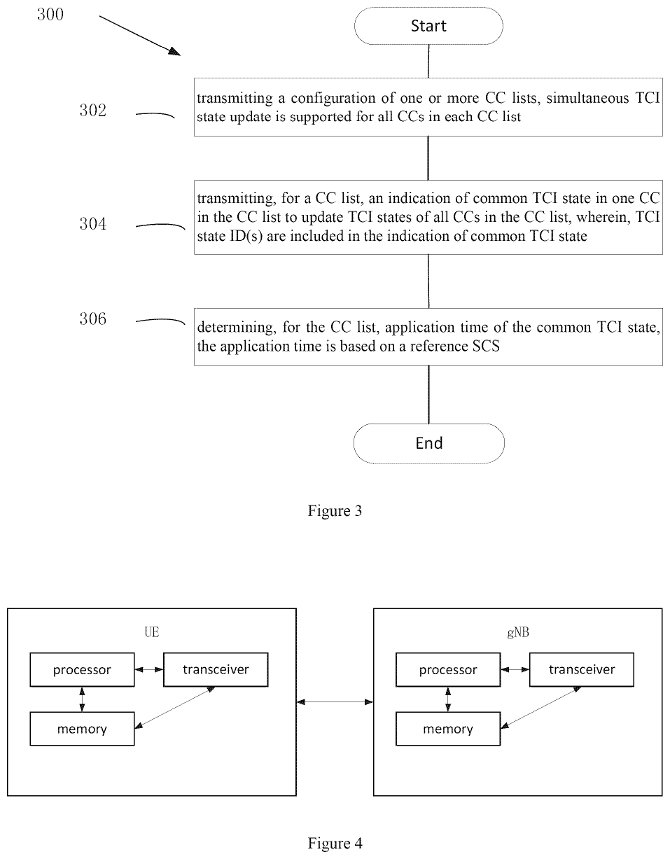

FIG. 3 is a schematic flow chart diagram illustrating a further embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may include 302 transmitting a configuration of one or more CC lists, simultaneous TCI state update is supported for all CCs in each CC list; 304 transmitting, for a CC list, an indication of common TCI state in one CC in the CC list to update TCI states of all CCs in the CC list, wherein, TCI state ID(s) are included in the indication of common TCI state; and 306 determining, for the CC list, application time of the common TCI state, the application time is based on a reference SCS.

In one embodiment, for a UE configured with joint DL/UL TCI, each CC list is one of simultaneousTCI-UpdateList1-r16 and simultaneousTCI-UpdateList2-r16 supported in NR Release 16, and for a UE configured with separate DL/UL TCI, each CC list for simultaneous DL TCI state update is one of simultaneousTCI-UpdateList1-r16 and simultaneousTCI-UpdateList2-r16 supported in NR Release 16, and each CC list for simultaneous UL TCI state update is one of simultaneousSpatial-UpdatedList1-r16 and simultaneousSpatial-UpdatedList2-r16 supported in NR Release 16. In some embodiment, for a UE configured with inter-band CA, all CCs within a same CC list are configured with either joint DL/UL TCI or separate DL/UL TCI, and for a UE configured with intra-band CA, all the configured CCs belong to a same CC list, and a higher layer parameter is configured to enable simultaneous TCI state update for all the configured CCs of the same CC list.

In another embodiment, the method may further comprise determining a reference CC of each CC list if at least one CC in the CC list is not configured with a TCI state pool. One reference CC may be explicitly configured for each CC list. For a CC without configured TCI state pool, a reference CC may be contained in the PDSCH configuration for the cell corresponding to the CC. The reference CC of each CC list may be determined by the follow steps: if the CC corresponding to a PCell is contained in the CC list, the CC corresponding to the PCell is determined as the reference CC; else if the CC corresponding to a PSCell is contained in the CC list, the CC corresponding to the PSCell is determined as the reference CC; otherwise, the CC corresponding to the cell with the lowest serving cell ID among all the cells, the corresponding CCs of which belong to the CC list, is determined as the reference CC. Alternatively, the CC corresponding to the cell with the lowest serving cell ID among all the cells, the corresponding CCs of which belong to the CC list, may be directly determined as the reference CC.

In some embodiment, the reference SCS of each CC list is determined by one of: the smallest SCS among SCSs of all the CCs in the CC list; the largest SCS among SCSs of all the CCs in the CC list; the SCS configured for the reference CC of the CC list; and the SCS configured for the CC in which the PUCCH carrying the acknowledgment for the indication of common TCI state is transmitted.

FIG. 4 is a schematic block diagram illustrating apparatuses according to one embodiment.

Referring to FIG. 4, the UE (i.e. the remote unit) includes a processor, a memory, and a transceiver. The processor implements a function, a process, and/or a method which are proposed in FIG. 2.

The UE comprises a receiver that receives a configuration of one or more CC lists, simultaneous TCI state update is supported for all CCs in each CC list, and receives, for a CC list, an indication of common TCI state in one CC in the CC list to update TCI states of all CCs in the CC list, wherein, TCI state ID(s) are included in the indication of common TCI state; and a processor that determines, for the CC list, application time of the common TCI state, the application time is based on a reference SCS, and applies the TCI state ID(s) included in the indication of common TCI state to all of CCs in the CC list after the determined application time.

In one embodiment, for a UE configured with joint DL/UL TCI, each CC list is one of simultaneousTCI-UpdateList1-r16 and simultaneousTCI-UpdateList2-r16 supported in NR Release 16, and for a UE configured with separate DL/UL TCI, each CC list for simultaneous DL TCI state update is one of simultaneousTCI-UpdateList1-r16 and simultaneousTCI-UpdateList2-r16 supported in NR Release 16, and each CC list for simultaneous UL TCI state update is one of simultaneousSpatial-UpdatedList1-r16 and simultaneousSpatial-UpdatedList2-r16 supported in NR Release 16. In some embodiment, for a UE configured with inter-band CA, all CCs within a same CC list are configured with either joint DL/UL TCI or separate DL/UL TCI, and for a UE configured with intra-band CA, all the configured CCs belong to a same CC list, and a higher layer parameter is configured to enable simultaneous TCI state update for all the configured CCs of the same CC list.

In another embodiment, the processor may further determine a reference CC of each CC list if at least one CC in the CC list is not configured with a TCI state pool. One reference CC may be explicitly configured for each CC list. For a CC without configured TCI state pool, a reference CC may be contained in the PDSCH configuration for the cell corresponding to the CC. The reference CC of each CC list may be determined by the follow steps: if the CC corresponding to a PCell is contained in the CC list, the CC corresponding to the PCell is determined as the reference CC; else if the CC corresponding to a PSCell is contained in the CC list, the CC corresponding to the PSCell is determined as the reference CC; otherwise, the CC corresponding to the cell with the lowest serving cell ID among all the cells, the corresponding CCs of which belong to the CC list, is determined as the reference CC. Alternatively, the CC corresponding to the cell with the lowest serving cell ID among all the cells, the corresponding CCs of which belong to the CC list, may be directly determined as the reference CC.

In some embodiment, the reference SCS of each CC list is determined by one of: the smallest SCS among SCSs of all the CCs in the CC list; the largest SCS among SCSs of all the CCs in the CC list; the SCS configured for the reference CC of the CC list; and the SCS configured for the CC in which the PUCCH carrying the acknowledgment for the indication of common TCI state is transmitted.

In some embodiment, the processor may further update a PL-RS for PUSCH or PUCCH transmission when the receiver receives the indication of common TCI state; and update the setting of (P0, alpha, closed loop index) for PUSCH and PUCCH transmissions when the receiver receives the indication of common TCI state. If the cell corresponding to a CC is configured with TCI state pool(s) and each joint DL/UL TCI state or UL TCI state is associated with a PL-RS, the PL-RS is updated with the PL-RS associated with the joint DL/UL TCI state or UL TCI state configured in the CC having the same TCI state ID that is indicated or activated as the new TCI state; and if the cell corresponding to a CC is not configured with TCI state pool, the PL-RS is updated with the PL-RS associated with indicated or activated joint DL/UL TCI state or UL TCI state. If the cell corresponding to a CC is configured with TCI state pool(s) and a setting of (P0, alpha, closed loop index) for PUSCH transmission and a setting of (P0, closed loop index) for PUCCH transmission are associated with each joint DL/UL TCI state or UL TCI state, the (P0, alpha, closed loop index) is updated for PUSCH transmission with that associated with the joint DL/UL TCI state or UL TCI state configured in the CC having the same TCI state ID that is indicated or activated as the new TCI state, and the (P0, closed loop index) for PUCCH transmission is updated with that associated with that associated with the joint DL/UL TCI state or UL TCI state configured in the CC having the same TCI state ID that is indicated or activated as the new TCI state.

Referring to FIG. 4, the gNB (i.e. base unit) includes a processor, a memory, and a transceiver. The processors implement a function, a process, and/or a method which are proposed in FIG. 3.

The base unit comprises a transmitter that transmits a configuration of one or more CC lists, simultaneous TCI state update is supported for all CCs in each CC list, and transmits, for a CC list, an indication of common TCI state in one CC in the CC list to update TCI states of all CCs in the CC list, wherein, TCI state ID(s) are included in the indication of common TCI state; and a processor that determines, for the CC list, application time of the common TCI state, the application time is based on a reference SCS.

In one embodiment, for a UE configured with joint DL/UL TCI, each CC list is one of simultaneousTCI-UpdateList1-r16 and simultaneousTCI-UpdateList2-r16 supported in NR Release 16, and for a UE configured with separate DL/UL TCI, each CC list for simultaneous DL TCI state update is one of simultaneousTCI-UpdateList1-r16 and simultaneousTCI-UpdateList2-r16 supported in NR Release 16, and each CC list for simultaneous UL TCI state update is one of simultaneousSpatial-UpdatedList1-r16 and simultaneousSpatial-UpdatedList2-r16 supported in NR Release 16. In some embodiment, for a UE configured with inter-band CA, all CCs within a same CC list are configured with either joint DL/UL TCI or separate DL/UL TCI, and for a UE configured with intra-band CA, all the configured CCs belong to a same CC list, and a higher layer parameter is configured to enable simultaneous TCI state update for all the configured CCs of the same CC list.

In another embodiment, the processor may further determine a reference CC of each CC list if at least one CC in the CC list is not configured with a TCI state pool. One reference CC may be explicitly configured for each CC list. For a CC without configured TCI state pool, a reference CC may be contained in the PDSCH configuration for the cell corresponding to the CC. The reference CC of each CC list may be determined by the follow steps: if the CC corresponding to a PCell is contained in the CC list, the CC corresponding to the PCell is determined as the reference CC; else if the CC corresponding to a PSCell is contained in the CC list, the CC corresponding to the PSCell is determined as the reference CC; otherwise, the CC corresponding to the cell with the lowest serving cell ID among all the cells, the corresponding CCs of which belong to the CC list, is determined as the reference CC. Alternatively, the CC corresponding to the cell with the lowest serving cell ID among all the cells, the corresponding CCs of which belong to the CC list, may be directly determined as the reference CC.

In some embodiment, the reference SCS of each CC list is determined by one of: the smallest SCS among SCSs of all the CCs in the CC list; the largest SCS among SCSs of all the CCs in the CC list; the SCS configured for the reference CC of the CC list; and the SCS configured for the CC in which the PUCCH carrying the acknowledgment for the indication of common TCI state is transmitted.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A user equipment (UE) configured with a unified transmission configuration indicator (TCI) framework, comprising:
a processor; and
a memory coupled with the processor, the processor configured to cause the UE to:
receive a configuration of one or more component carrier (CC) lists,
wherein simultaneous TCI state update is supported for all CCs in each CC list;
receive, for a CC list, an indication of common TCI state in one CC in the CC list to update TCI states of all CCs in the CC list,
wherein TCI state ID(s) are included in an indication of common TCI state;
determine, for the CC list, an application time of the common TCI state,
wherein the application time is based on a reference subcarrier spacing (SCS); and
apply the TCI state ID(s) included in the indication of common TCI state to all of CCs in the CC list after the determined application time.

17. The UE of claim 16, wherein the processor is further configured to cause the UE to: receive a configuration of a reference CC in a Physical Downlink Shared Channel (PDSCH) configuration when the reference CC is not configured with a TCI state pool.

18. The UE of claim 16, wherein,
when the UE is configured with joint downlink/uplink (DL/UL) TCI, each CC list is one of simultaneousTCI-UpdateList1-r16 and simultaneousTCI-UpdateList2-r16 supported in NR Release 16, and
when the UE is configured with separate DL/UL TCI, each CC list for simultaneous DL TCI state update is one of simultaneousTCI-UpdateList1-r16 and simultaneousTCI-UpdateList2-r16 supported in NR Release 16, and each CC list for simultaneous UL TCI state update is one of simultaneousSpatial-UpdatedList1-r16 and simultaneousSpatial-UpdatedList2-r16 supported in NR Release 16.

19. The UE of claim 16, wherein,
when the UE is configured with inter-band carrier aggregation (CA), all CCs within a same CC list are configured with either joint DL/UL TCI or separate DL/UL TCI, and
when the UE is configured with intra-band CA, all the configured CCs belong to a same CC list, and a higher layer parameter is configured to enable simultaneous TCI state update for all the configured CCs of the same CC list.

20. The UE of claim 17, wherein, one reference CC is explicitly configured for each CC list.

21. The UE of claim 17, wherein the processor is further configured to cause the UE to determine the reference CC of each CC list by:
if a CC corresponding to a PCell is contained in the CC list, the CC corresponding to the PCell is determined as the reference CC; or
if a CC corresponding to a PSCell is contained in the CC list, the CC corresponding to the PSCell is determined as the reference CC;
if no CC corresponds to a PCell or a PSCell, a CC corresponding to a cell with a lowest serving cell ID among all cells is determined as the reference CC.

22. The UE of claim 17, wherein a CC corresponding to a cell with a lowest serving cell ID among all cells is determined as the reference CC.

23. The UE of claim 16, wherein the processor is further configured to cause the UE to determine the reference SCS as:
a smallest SCS among SCSs of all the CCs in the CC list;
a largest SCS among SCSs of all the CCs in the CC list;
a SCS configured for the reference CC of the CC list; or
a SCS configured for the CC in which a Physical Uplink Control Channel (PUCCH) carrying an acknowledgment for the indication of common TCI state is transmitted.

24. The UE of claim 16, wherein the processor is further configured to cause the UE to:
update a pathloss reference signal (PL-RS) for Physical Uplink Shared Channel (PUSCH) or Physical Uplink Control Channel (PUCCH) transmission when receiving the indication of common TCI state; and
update a setting of (P0, alpha, closed loop index) for PUSCH and PUCCH transmissions when receiving the indication of common TCI state.

25. The UE of claim 24,
if the cell corresponding to a CC is configured with a TCI state pool and each joint downlink/uplink (DL/UL) TCI state or UL TCI state is associated with a PL-RS, the PL-RS is updated with a PL-RS associated with a joint DL/UL TCI state or UL TCI state configured in the CC having the same TCI state ID that is indicated or activated as a new TCI state; and
if the cell corresponding to a CC is not configured with the TCI state pool, the PL-RS is updated with a PL-RS associated with an indicated or activated joint DL/UL TCI state or a UL TCI state.

26. The UE of claim 24, wherein,
if the cell corresponding to a CC is configured with TCI state pool(s) and a setting of (P0, alpha, closed loop index) for PUSCH transmission and a setting of (P0, closed loop index) for PUCCH transmission are associated with each joint DL/UL TCI state or UL TCI state, the (P0, alpha, closed loop index) is updated for PUSCH transmission that is associated with the joint DL/UL TCI state or UL TCI state configured in the CC having a same TCI state ID that is indicated or activated as a new TCI state, and the (P0, closed loop index) for PUCCH transmission is updated with the joint DL/UL TCI state or UL TCI state configured in the CC having the same TCI state ID that is indicated or activated as the new TCI state.

27. A base unit, comprising:
a processor; and
a memory coupled with the processor, the processor configured to cause the base unit to:
transmit a configuration of one or more component carrier (CC) lists,
wherein a simultaneous transmission configuration indicator (TCI) state update is supported for all CCs in each CC list;
transmit, for a CC list, an indication of common TCI state in one CC in the CC list to update TCI states of all CCs in the CC list,
wherein TCI state ID(s) are included in an indication of common TCI state; and
determine, for the CC list, an application time of the common TCI state,
wherein the application time is based on a reference subcarrier spacing (SCS).

28. The base unit of claim 27, wherein the processor is further configured to cause the base unit transmit a configuration of a reference CC in a Physical Downlink Shared Channel (PDSCH) configuration when the reference CC is not configured with a TCI state pool.

29. A processor for wireless communication that is configured with a unified transmission configuration indicator (TCI) framework, the processor comprising:
at least one controller coupled with at least one memory and configured to cause the processor to:
receive a configuration of one or more component carrier (CC) lists,
wherein simultaneous TCI state update is supported for all CCs in each CC list;
receive, for a CC list, an indication of common TCI state in one CC in the CC list to update TCI states of all CCs in the CC list,
wherein TCI state ID(s) are included in an indication of common TCI state;
determine, for the CC list, an application time of the common TCI state,
wherein the application time is based on a reference subcarrier spacing (SCS); and
apply the TCI state ID(s) included in the indication of common TCI state to all of CCs in the CC list after the determined application time.

30. The processor of claim 29, wherein the controller is further configured to cause the processor to: receive a configuration of a reference CC in a Physical Downlink Shared Channel (PDSCH) configuration when the reference CC is not configured with a TCI state pool.

31. The processor of claim 30, wherein one reference CC is explicitly configured for each CC list.

32. The processor of claim 30, wherein the controller is further configured to cause the processor to determine the reference CC of each CC list by:
if a CC corresponding to a PCell is contained in the CC list, the CC corresponding to the PCell is determined as the reference CC; or
if a CC corresponding to a PSCell is contained in the CC list, the CC corresponding to the PSCell is determined as the reference CC;
if no CC corresponds to a PCell or a PSCell, a CC corresponding to a cell with a lowest serving cell ID among all cells is determined as the reference CC.

33. The processor of claim 30, wherein a CC corresponding to a cell with a lowest serving cell ID among all cells is determined as the reference CC.

34. A method performed by a User Equipment (UE) that is configured with a unified transmission configuration indicator (TCI) framework, the method comprising:
receiving a configuration of one or more component carrier (CC) lists,
wherein simultaneous TCI state update is supported for all CCs in each CC list;
receiving, for a CC list, an indication of common TCI state in one CC in the CC list to update TCI states of all CCs in the CC list,
wherein TCI state ID(s) are included in an indication of common TCI state;
determining, for the CC list, an application time of the common TCI state,
wherein the application time is based on a reference subcarrier spacing (SCS); and
applying the TCI state ID(s) included in the indication of common TCI state to all of CCs in the CC list after the determined application time.

35. The method of claim 34, further comprising: receiving a configuration of a reference CC in a Physical Downlink Shared Channel (PDSCH) configuration when the reference CC is not configured with a TCI state pool.
